(19) United States
(12) Patent Application Publication
(10) Pub. No.: US 2024/0058748 A1
(43) Pub. Date: Feb. 22, 2024

(54) DEVICE AND METHOD FOR ELECTROCHEMICAL DEGRADATION OF GASEOUS ORGANIC POLLUTANTS

(71) Applicant: SHENZHEN PUREMATE TECHNOLOGY CO., LTD., Shenzhen (CN)

(72) Inventors: Lizhi ZHANG, Shenzhen (CN); Falong JIA, Shenzhen (CN); Yiqing YAN, Shenzhen (CN); Fangsheng YAN, Shenzhen (CN)

(73) Assignee: SHENZHEN PUREMATE TECHNOLOGY CO., LTD., Shenzhen (CN)

(21) Appl. No.: 18/261,077

(22) PCT Filed: Nov. 25, 2021
(86) PCT No.: PCT/CN2021/133034

§ 371 Date: Jul. 25, 2023

(30) Foreign Application Priority Data
Jan. 11, 2021 (CN) 202110039154.1

(51) Int. Cl. B01D 53/32; B01D 53/86; C25B 11/032; C25B 11/042; C25B 11/054; C25B 9/23; C25B 15/021

(52) U.S. Cl. CPC B01D 53/326; B01D 53/8687; C25B 11/032; C25B 11/042; C25B 11/054; C25B 9/23; C25B 15/021; B01D 2257/708

(57) ABSTRACT

Disclosed are a device and a method for degrading a gaseous organic pollutant through electrochemical process. The device includes an electrochemical reactor, where the electrochemical reactor includes a power supply, an anode, a cathode, a proton exchange membrane; and the proton exchange membrane is provided between the anode and the cathode, and the anode, the proton exchange membrane and the cathode are clamped, and the proton exchange membrane is a gas-permeable proton exchange membrane. The method is applied to the device, and includes: applying a direct current voltage between the cathode and the anode; and inputting a gas containing the gaseous organic pollutant from the anode. The gas containing the gaseous organic pollutant is degraded at the anode, and the degraded gas passes through the proton exchange membrane and the cathode in turn, and is discharged.

### CROSS-REFERENCE TO RELATED APPLICATIONS

This application is the National Stage of International Application No. PCT/CN2021/133034, filed on Nov. 25, 2021, which claims priority to Chinese Patent Application No. 202110039154.1, filed on Jan. 11, 2021, the entire contents of which are incorporated herein by reference.

### TECHNICAL FIELD

The present application relates to the technical field of purifying a gaseous organic pollutant, and in particular, to a device and a method for degrading a gaseous organic pollutant through electrochemical process.

### BACKGROUND

At present, there are many degradation methods for volatile gas-phase organic pollutants, but they all have problems. The electrochemical oxidation method is greatly concerned because it does not require the addition of any chemical reagents, and its operation is simple and green.

The proton exchange membrane in the electrochemical reactor adopted in the electrochemical oxidation method is generally non-gas-permeable structure, in the degradation process, the gaseous organic pollutant need to enter from the unilateral anode inlet channel, flow into the anode and are degraded in the interface of the anode and the proton exchange membrane, and then the degraded gas is diffused from the interface back to the anode inlet channel, so that the inlet gas and the outlet gas will be mixed with each other and the interference is produced, it is difficult to realize the effective degradation of pollutants at a high flow rate.

### SUMMARY

The main objective of the present application is to provide a device and a method for degrading a gaseous organic pollutant through electrochemical process, aiming at effectively enhancing the degradation efficiency at a high gas flow rate.

In order to achieve the above objective, the present application provides a device for degrading a gaseous organic pollutant through electrochemical process, including an electrochemical reactor, the electrochemical reactor includes a power supply, an anode, a cathode, a proton exchange membrane; and the proton exchange membrane is provided between the anode and the cathode, and the anode, the proton exchange membrane and the cathode are clamped, and the proton exchange membrane is a gas-permeable proton exchange membrane.

In an embodiment, an aperture of a pore in the gas-permeable proton exchange membrane ranges from 0.1 μm to 20,000 μm; and/or, a density of the pore in the gas-permeable proton exchange membrane ranges from 2 ppi to 10000 ppi.

In an embodiment, the gas-permeable proton exchange membrane has a thickness of 5 μm to 3000 μm.

In an embodiment, the anode is provided with a titanium suboxide material coating.

In an embodiment, the titanium suboxide material coating has a thickness of 0.1 μm to 500 μm.

In an embodiment, the anode is a gas-permeable metal electrode, and the gas-permeable metal electrode is one of a foam titanium electrode, a foam titanium alloy electrode, a titanium mesh electrode, and a titanium alloy mesh electrode.

In an embodiment, the cathode is a gas-permeable electrode loaded with an oxygen reduction catalyst, the oxygen reduction catalyst is made of at least one of platinum, rhodium, ruthenium, palladium, nickel, cobalt oxide, iron compounds, and molybdenum compounds; the gas-permeable electrode is one of a carbon paper electrode, a carbon fiber fabric electrode, a foam nickel electrode, a foam titanium electrode, a foam titanium alloy electrode, a titanium mesh foam electrode, and a titanium alloy mesh foam electrode; and/or, a plurality of electrochemical reactors are provided in series.

The present application provides a method for degrading the gaseous organic pollutant through electrochemical process, applied to the device for degrading the gaseous organic pollutant through electrochemical process, including:
applying a direct current voltage between the cathode and the anode; and
inputting a gas containing the gaseous organic pollutant from the anode; where the gas containing the gaseous organic pollutant is degraded at the anode, and the degraded gas passes through the proton exchange membrane and the cathode in turn, and is discharged.

In an embodiment, the gas containing the gaseous organic pollutant has a relative humidity of 2% to 100%.

In an embodiment, the direct current voltage ranges from 0.3V to 36V; and/or, a temperature during a degradation of the gaseous organic pollutant is controlled to be in a range of −40° C. to 70° C.

The technical solution of the present application uses the device for degrading the gaseous organic pollutant through electrochemical process to degrade the gaseous organic pollutant, the proton exchange membrane of the electrochemical reactor is a permeable proton exchange membrane, so that in the degradation of gaseous organic pollutants, the degraded gas directly passes through the proton exchange membrane and the cathode and then is discharged out of the reaction device, and will not be mixed with the subsequent incoming gases to be degraded, and thus the degradation efficiency at a high gas flow rate can be effectively improved, and the overall structure of the device of the present application is more compact. In addition, the device for degrading the gaseous organic pollutant through electrochemical process of the present application is applicable to the degradation of all gaseous organic pollutants, and is not limited by the water solubility of organic pollutants, with a wide range of applications, and has a great potential for application in the field of environmental pollution management.

### BRIEF DESCRIPTION OF THE DRAWINGS

In order to more clearly illustrate the technical solutions in the embodiments of the present application or prior art, the drawings to be used in the description of the embodiments or prior art will be briefly introduced below, and it will be obvious that the drawings in the following description are only some of the embodiments of the present application, and that other drawings can be obtained by those skilled in the art without creative labor according to the structures in the drawings.

FIG. 1 is a schematic structural view of a device for degrading the gaseous organic pollutant through electrochemical process according to an embodiment of the present application.

FIG. 2 is a schematic diagram of comparing the performance of two structures of electrochemical reactors for degrading benzene pollutants.

FIG. 3 is a schematic diagram of a ratio of reactive benzene degradation to CO₂ and CO.

FIG. 4 is a schematic diagram of a relationship between the benzene degradation efficiency, the current density and time under a long period of continuous electrolysis.

Reference numbers:

| Number | Name |
|---|---|
| 1 | gas-permeable electrode |
| 2 | gas-permeable proton exchange membrane |
| 3 | gas-permeable cathode |

The realization of the purpose, functional features and advantages of the present application will be further described in conjunction with the embodiments and with reference to the drawings.

### DETAILED DESCRIPTION OF THE EMBODIMENTS

The technical solutions in the embodiments of the present application will be described clearly and completely in the following, and it is obvious that the described embodiments are only a part of the embodiments of the present application and not all of the embodiments. Based on the embodiments in the present application, all other embodiments obtained by those skilled in the art without creative labor fall within the scope of the present application.

In addition, the technical solutions among the various embodiments can be combined with each other, but it must be based on the fact that it can be realized by those skilled in the art, and when the combination of the technical solutions is contradictory or cannot be achieved, it should be considered that the combination of such technical solutions does not exist, and is not within the scope of the present application.

The present application provides a device for degrading the gaseous organic pollutant through electrochemical process, which is configured to degrade the gaseous organic pollutant.

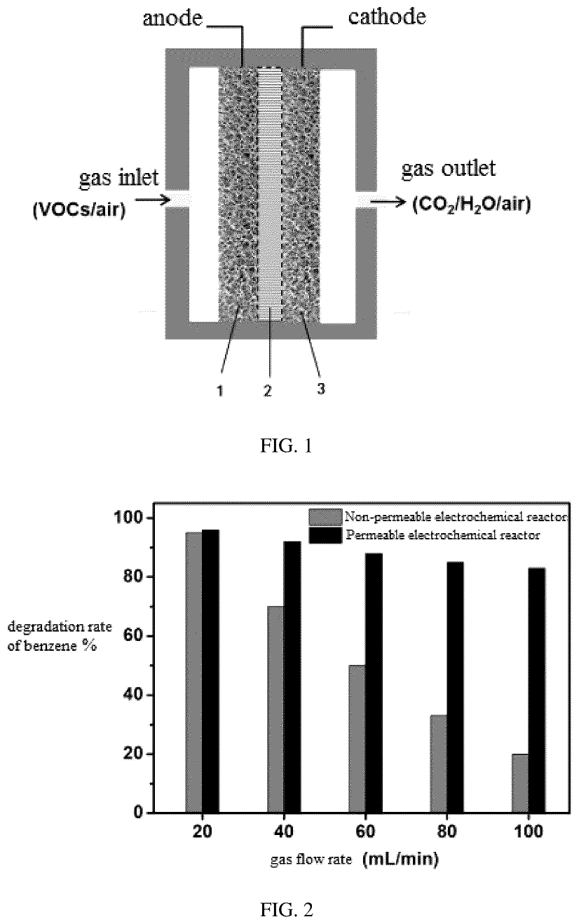

Referring to FIG. 1, in an embodiment of the present application, the device for degrading the gaseous organic pollutant through electrochemical process includes an electrochemical reactor, where the electrochemical reactor includes a power supply, an anode, a cathode, a proton exchange membrane; and the proton exchange membrane is provided between the anode and the cathode, and the anode, the proton exchange membrane and the cathode are clamped, and the proton exchange membrane is a gas-permeable proton exchange membrane.

Here, the power supply is a direct current power supply, the gas inlet channel is provided for admitting a gas containing the gaseous organic pollutant, the anode is installed in the gas inlet channel, the cathode is installed in the gas outlet channel, the proton exchange membrane is installed between the cathode and the anode, and the anode, the proton exchange membrane, and the cathode are provided in a three-layer clamping form, so that the electrochemical reactor can be assembled. Moreover, the proton exchange membrane is a gas-permeable proton exchange membrane, so that the degraded gas directly passes through the proton membrane and the cathode and is discharged out of the reaction device, and will not mix with the subsequent incoming gases to be degraded, so that the degradation efficiency at a high gas flow rate can be effectively improved, and such an arrangement makes the overall structure of the device more compact.

It should be noted that the cathode area of a non-gas-permeable electrochemical reactor needs to be equipped with a separate gas inlet system, and the whole device needs two sets of gas control system. However, the present application adopts a gas-permeable electrochemical reactor, which does not need to be equipped with a separate gas inlet system for the cathode, and the whole device requires only one set of gas control system, which further optimizes the structure of the device and reduces the cost.

Understandably, the technical solution of the present application uses the device for degrading the gaseous organic pollutant through electrochemical process to degrade the gaseous organic pollutant, the proton exchange membrane of the electrochemical reactor is a permeable proton exchange membrane, so that in the degradation of gaseous organic pollutants, the degraded gas directly passes through the proton exchange membrane and the cathode and then is discharged out of the reaction device, and will not be mixed with the subsequent incoming gases to be degraded, and thus the degradation efficiency at a high gas flow rate can be effectively improved, and the overall structure of the device of the present application is more compact. In addition, the device for degrading the gaseous organic pollutant through electrochemical process of the present application is applicable to the degradation of all gaseous organic pollutants, and is not limited by the water solubility of organic pollutants, with a wide range of applications, and has a great potential for application in the field of environmental pollution management.

In the embodiment, the device for degrading the gaseous organic pollutant through electrochemical process further includes a transportation device, a transportation pipeline, and a gas inlet channel and a gas outlet channel, the transportation pipeline is connected to the gas inlet channel and the gas outlet channel, and the transportation pipeline is provided with a transportation device, and the transportation device is a fan or an air pump.

When designing the proton exchange membrane, in order to effectively ensure that the degraded gas smoothly passes through the proton exchange membrane, it is necessary to reasonably control the aperture of the pore in the permeable proton exchange membrane. In an embodiment, the aperture of the pore in the gas-permeable proton exchange membrane ranges from 0.1 μm to 20,000 μm, such as, for example, the aperture of the pore in the gas-permeable proton exchange membrane is 0.1 μm, 1 μm, 3 μm, 5 μm, 7 μm, 10 μm, 12 μm, 15 μm, 17.5 μm, 20 μm, 200 μm, 1000 μm, 2000 μm, 3000 μm, 4000 μm, 5000 μm, 6000 μm, 7000 μm, 8000 μm, 9000 μm, 10000 μm, 150,000 μm, 20000 μm.

It is also necessary to reasonably control the density of the pores in the gas-permeable proton exchange membrane, optionally, the density of the pores in the gas-permeable proton exchange membrane ranges from 2 ppi to 10,000 ppi, such as the density of the pores in the gas-permeable proton exchange membrane is 2 ppi, 5 ppi, 50 ppi, 100 ppi, 200 ppi, 300 ppi, 400 ppi, 500 ppi, 600 ppi, 700 ppi, 700 ppi, 800 ppi, 900 ppi, 1000 ppi, 500 ppi, 5000 ppi, 10000 ppi.

In an embodiment, the thickness of the gas-permeable proton exchange membrane ranges from 5 μm-3000 μm, for example, the thickness of the gas-permeable proton exchange membrane is 5 μm, 10 μm, 20 μm, 30 μm, 50 μm, 100 μm, 150 μm, 200 μm, 250 μm, 500 μm, 1000 μm, 2000 μm, or 3000 μm. The permeable exchange membrane of these thicknesses can ensure its strength and also realize the smooth transmission of the degraded gas.

In an embodiment, the surface of the anode is provided with a titanium suboxide material coating. The titanium suboxide material coating may be provided on the surface of the anode by coating, spraying, impregnating or other means. The main active component of the titanium suboxide material is Ti₄O₇, and compared with boron-doped diamond and SnO₂ electrode materials, the titanium suboxide material has a higher oxygen precipitation overpotential, which is conducive to efficiently oxidizing water molecules adsorbed on the surface to hydroxyl radicals, thereby realizing efficient degradation of gaseous organic pollutants. The titanium suboxide material also has good electrical conductivity and chemical stability, and the service life of the electrochemical reactor is substantially improved, thereby enabling the device for degrading the gaseous organic pollutant through electrochemical process to have excellent long-lasting stability, with obvious advantages in terms of the reliability of the practical application.

Understandably, the present application uses a gas-permeable proton exchange membrane in combination with an anode of titanium suboxide material, which can further improve the efficiency of electrochemical degradation of gaseous organic pollutants.

In making the anode, the thickness of the titanium suboxide material coating is reasonably controlled to be fully effective. In an embodiment, the thickness of the titanium suboxide material coating ranges from 0.1 μm to 500 μm, for example, the thickness of the titanium suboxide material coating is 0.1 μm, 1 μm, 2.5 μm, 5 μm, 10 μm, 15 μm, 20 μm, 30 μm, 50 μm, 100 μm, 200 μm, 400 μm, or 500 μm. It is to be understood that if the thickness of the titanium suboxide material coating is less than 0.1 μm, the titanium suboxide material has a smaller role, cannot efficiently oxidize the water molecules adsorbed on the surface to hydroxyl radicals, and the degradation rate of the gaseous organic pollutant is not high; if the thickness of the titanium suboxide material coating is greater than 500 μm, some of the titanium suboxide material will not be able to give full play to its role, resulting in a waste of materials and a high cost.

In the embodiment, the anode is a gas-permeable metal electrode, and the gas-permeable metal electrode is one of a foam titanium electrode, a foam titanium alloy electrode, a titanium mesh electrode, and a titanium alloy mesh electrode.

Here, the anode is a gas-permeable metal electrode, so that when processing a gas containing the gaseous organic pollutant, the gas can pass through the anode, so that the gaseous organic pollutant therein can be removed more efficiently. When selecting the gas-permeable metal electrode, one of a foam titanium electrode, a foam titanium alloy electrode, a titanium mesh electrode, and a titanium alloy mesh electrode may be selected.

In an embodiment, the cathode is a gas-permeable electrode loaded with an oxygen reduction catalyst, the oxygen reduction catalyst is made of at least one of platinum, rhodium, ruthenium, palladium, nickel, cobalt oxide, iron compounds, and molybdenum compounds; the gas-permeable electrode is one of a carbon paper electrode, a carbon fiber fabric electrode, a foam nickel electrode, a foam titanium electrode, a foam titanium alloy electrode, a titanium mesh foam electrode, and a titanium alloy mesh foam electrode.

Here, the cathode is a gas-permeable electrode, which allows the degraded gas to pass through, and the oxygen molecules in the gas are reduced under the action of the oxygen reduction catalyst in the cathode, and the hydrogen ions generated by the anodic oxidation of the anode migrate to the interface of the cathodic through the proton exchange membrane, and combine with the oxygen molecules restored on the cathode to produce water, then a stable electrolytic reaction circuit is constituted and the smooth progress of electrochemical degradation of the gas organic pollutants is ensured.

In an embodiment, the oxygen reduction catalyst is loaded in a range of 0.1 mg/cm² to 100 mg/cm², such as the oxygen reduction catalyst is loaded in a range of 0.1 mg/cm², 1.0 mg/cm², 5.0 mg/cm², 10.0 mg/cm², 20.0 mg/cm², 30.0 mg/cm², 40.0 mg/cm², 50.0 mg/cm², 70.0 mg/cm² or 100.0 mg/cm².

In an embodiment, the plurality of electrochemical reactors are provided in series. In this way, the degradation efficiency of the organic pollutants can be effectively improved.

The present application also provides a method for degrading the gaseous organic pollutant through electrochemical process, applied to the device for degrading the gaseous organic pollutant through electrochemical process as described before, including:
applying a direct current voltage between the cathode and the anode;
inputting a gas containing the gaseous organic pollutant from the anode; where the gas containing the gaseous organic pollutant is degraded at the anode, and the degraded gas passes through the proton exchange membrane and the cathode in turn, and is discharged.

Here, the gas containing the gaseous organic pollutant contains a certain amount of gaseous water molecules, and after passing through the anode into the anode inlet channel, the gaseous water molecules will be oxidized to generate hydroxyl radical active species after adsorption on the surface of the titanium suboxide anode, and then the volatile organic components in the gas are oxidized and degraded, so that the volatile organic components are decomposed into harmless small molecules such as carbon dioxide. The degraded gas enters the gas-permeable cathode through the gas-permeable proton exchange membrane, and the oxygen molecules in the gas are reduced at the cathode, and hydrogen ions generated by anodic oxidation degradation migrate to the interface of the cathode through the proton exchange membrane and combine with the oxygen molecules reduced on the cathode to generate water, a stable electrolytic reaction circuit is constituted, and the smooth progress of electrochemical degradation of pollutants is ensured. Ultimately, the degraded gas is discharged out of the cathode outlet channel.

Understandably, the present application adopts a gas-permeable electrochemical reactor, which does not need to be equipped with a separate gas inlet system for the cathode, and the whole device only needs a set of gas control system, further optimizing the device structure and reducing the cost. In the process of degrading the gaseous organic pollutant, the degraded gas directly passes through the proton exchange membrane and the cathode and is discharged out of the reaction device, and will not mix with the subsequent incoming gases to be degraded, the degradation efficiency at a high gas flow rate is effectively improved, and the overall structure of the device of the present application is more compact. Further, the anode of the present application is coated with titanium suboxide material, and the oxygen precipitation overpotential of the titanium suboxide material is higher than that of the boron doped diamond and SnO₂ electrode material, and thus the water molecules adsorbed on the surface can be efficiently oxidized into hydroxyl radical active species, and then the volatile organic components in the degraded gas are oxidized, so that the volatile organic components are decomposed into harmless molecules such as carbon dioxide, to achieve the efficient degradation of gaseous organic pollutants. The titanium suboxide material also has good electrical conductivity and chemical stability, the service life of the electrochemical reactor is greatly improved, so that the device for degrading the gaseous organic pollutant through electrochemical process has excellent long-lasting stability, with obvious advantages in terms of the reliability of the practical application.

The relative humidity of the gas containing the gaseous organic pollutant affects the degradation efficiency of the gaseous organic pollutant, so it is necessary to control the relative humidity, optionally, the relative humidity of the gas containing the gaseous organic pollutant is controlled to be in a range of 2% to 100%, for example, the relative humidity of the gas containing the gaseous organic pollutant is 2%, 5%, 10%, 20%, 30%, 40%, 50%, 60%, 80%, or 100%.

In the embodiment, the direct current (DC) voltage ranges from 0.3 V to 36 V. The DC voltage is applied in a range of 0.3 V to 36 V between the cathode and the anode during the operation of the electrochemical reactor, which enables the electrochemical method to effectively degrade the gaseous organic pollutant.

In the process of using the electrochemical method to degrade the gaseous organic pollutant, the temperature in the process of degrading the gaseous organic pollutant is reasonably controlled, and the degradation temperature is controlled to be in a range of −40° C. to 70° C., to be conducive to improving the degradation rate of the gaseous organic pollutant. Optionally, the degradation temperature thereof is controlled to be in a range of 5° C. to 40° C.

The device and the method for degrading the gaseous organic pollutant through electrochemical process of the present application are described in detail below by means of specific embodiments.

### Embodiment 1

The method and device for degrading gaseous volatile organic pollutant through a permeable gas-solid phase electrochemical process based on a titanium suboxide anode of the present application are shown in FIG. 1. The device includes an electrochemical reactor, the electrochemical reactor includes a permeable metal anode 1 loaded with a titanium suboxide, a permeable proton exchange membrane 2, and a permeable cathode 3 loaded with an oxygen reduction catalyst, and the components are tightly affixed together by a locking mechanism. When degrading the gaseous organic pollutants, a voltage is applied between the cathode and the anode, and the gas containing volatile gaseous organic pollutants is input from the anode, and the volatile gaseous organics are oxidized and degraded to carbon dioxide and water on the surface of the anode, and the degraded gas passes through the gas-permeable proton exchange membrane to enter the gas-permeable cathode, and is finally discharged out of the cathode.

### Embodiment 2

(1) Preparation of a gas-permeable metal anode loaded with a titanium suboxide: A titanium foam sheet with a filtration precision of 50 μm is set as a substrate loaded with a titanium suboxide. Firstly, the titanium foam is put into acetone for ultrasonic degreasing and washing, and then it is immersed into 10 wt % oxalic acid solution and treated at 80° C. for 2 hours to remove the oxidized layer on the surface of the titanium material; and then the titanium suboxide is sprayed onto the titanium foam by using the plasma spraying method, with a spraying power of 30 KW, and the spraying thickness is controlled to be 15 μm through the adjustment of spraying volume. After spraying, the titanium foam is cleaned with ethanol and dried, to obtain the titanium suboxide-loaded titanium foam, which is used as the anode of the subsequent gas-solid phase electrochemical reactor.

(2) Preparation of the gas-permeable cathode loaded with oxygen reduction catalyst: the nickel foam is set as the cathode carrier, which is first degreased by electrolysis and washed with water, and then immersed in 0.1M hydrochloric acid solution for 10 min to remove the oxidized layer, and then immersed in 0.01M chloroplatinic acid solution for 3 min, and then taken out to be washed with water and blown dry.

### Embodiment 3

Preparation of the gas-permeable proton exchange membrane: it can be prepared by the following three methods.

Method 1: the commercial proton exchange membrane with a thickness of 150 μm is set as a substrate, and is placed on a silica gel plate with a flat surface, and additionally a steel plate with a surface covered with micron-sized pinpoints is processed, the diameter and height of the pinpoints on the steel plate are 5 μm and 200 μm, respectively, and the distribution density of the pinpoints is 5000/cm², the pinpoints of the steel plate face the proton exchange membrane and is placed thereon, and 1 MPa is applied between the steel plate and the silica gel plate for 2 min. Subsequently, the proton exchange membrane is removed to obtain the permeable proton exchange membrane.

Method 2: 10% perfluorosulfonic acid resin dispersion is set as raw material, and gradually dropped onto the steel plate covered with micron-sized pinpoints, the diameter and height of the pinpoints on the steel plate are 5 μm and 200 μm, respectively. The surface of the steel plate is heated with 50° C., and the amount and frequency of dropping are controlled, and then the formed membrane is removed from the steel plate after the solvent is evaporated, to obtain the permeable plasmon-exchange membrane.

Method 3: a commercial proton exchange membrane with a thickness of 150 μm is set as the substrate, and the laser irradiation is used to punch through holes in the membrane. The size of the laser spot, laser power and running trajectory are adjusted to form densely distributed through-holes on the proton membrane with an aperture of 10 μm and a distribution density of 5000 holes/cm².

### Embodiment 4

(1) Assembly of the electrochemical reactor: a permeable proton exchange membrane prepared in Embodiment 3 is placed between the anode and cathode prepared in Embodiment 2 above, and the membrane electrode set is obtained by hot pressing with 6 MPa for 2 minutes at 80° C. Subsequently, the membrane electrode group is clamped between the anode inlet channel and the cathode outlet channel, and the anode and the cathode are connected to the positive and negative poles of a DC power supply through wires, respectively, to obtain a permeable gas-solid phase electrochemical reactor.

(2) Removal of gaseous pollutants by gas-solid-phase electrochemical reactor: gas containing typical volatile organic pollutants—“benzene” (relative humidity of 60%) is input into the anode inlet channel, with a benzene concentration of 10 ppm, and a DC voltage of 4V is applied between the anode and cathode, to control gas inlet flow rate and monitor the pollutant concentration at the cathode outlet, and the dimensions of the anode and cathode for testing are 4 cm (length)×4 cm (width)×1 mm (thickness).

### Embodiment 5

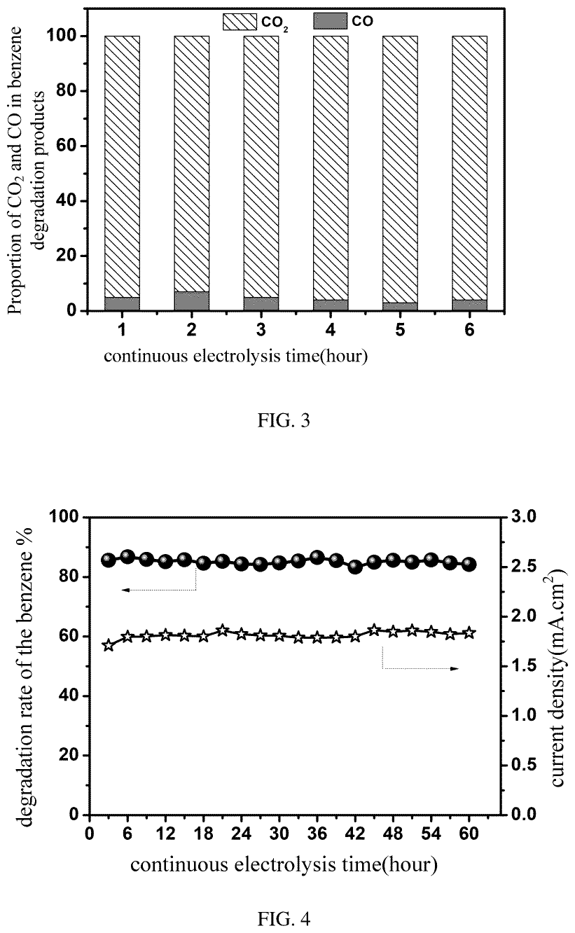

Degradation efficiency of volatile organic pollutants—benzene at different flow rates: a gas-solid phase electrochemical reaction device assembled in Embodiment 4 is used, a DC voltage of 4V is applied between the anode and the cathode, the relative humidity of the inlet gas is controlled to be 60%, the concentration of benzene in the inlet gas is 10 ppm, and the gas flow rate is increased from 20 mL/min to 100 mL/min, and the catalytic performances are shown in FIGS. 2 and 3. It can be seen that a high benzene degradation rate (>80%) can still be achieved when the gas flow rate is increased from 20 mL/min to 100 mL/min by using a permeable electrochemical reactor, a high benzene degradation rate (>80%) can still be obtained. However, if a non-permeable electrochemical device is used, i.e., an impermeable proton exchange membrane is used, the anode is fed with gas and then discharged from the anode area, and all other conditions are the same as those of the permeable electrochemical reactor, the benzene degradation rate decreases with the increase of the gas flow rate, and there is only a 20% degradation rate in the case of 100 mL/min. The above results fully demonstrate that the permeation type electrochemical device has excellent performance under a high gas flow rate. Moreover, the product of benzene degradation by the permeation-type electrochemical device is mainly CO₂ (95%), indicating that the gas-solid-phase electrochemistry based on titanium suboxide anode can mineralize benzene efficiently.

### Embodiment 6

Stability test of gas-solid-phase electrochemical degradation of volatile organic compounds: Using the gas-solid-phase electrochemical reaction device assembled in Embodiment 4, gas containing a typical volatile organic pollutant-“benzene” (relative humidity of 60%) is passed into the anode inlet channel, with a concentration of benzene of 10 ppm, and a gas flow rate of 100 mL/min. Then a voltage of 4V is applied between the anode and cathode, and the concentration of the benzene pollutant and the current at the cathode outlet are monitored. The relationship between degradation efficiency of the benzene, the current density and time under long-time continuous electrolysis are shown in FIG. 4. From FIG. 4, it can be seen that the degradation rate of the benzene is maintained at about 83% during the continuous degradation process for 60 h and the current density is basically stabilized at about 1.8 mA·cm², which indicates that the titanium suboxide electrode can be used for the degradation of benzene for a long time under the continuous electrolysis process. This indicates that the titanium suboxide electrode can still maintain stable electrical conductivity and electrocatalytic performance under prolonged anodic polarization, and also reflects the excellent stability of the surface structure of the electrode material.

The above is only some embodiments of the present application, and is not intended to limit the scope of the present application, and all equivalent structural transformations made under the inventive concept of the present application by using the specification of the present application, or direct/indirect application in other related technical fields are included in the scope of the present application.

1. A device for degrading a gaseous organic pollutant through electrochemical process, comprising:
an electrochemical reactor comprising a power supply, an anode, a cathode, and a proton exchange membrane provided between the anode and the cathode,
wherein the anode, the proton exchange membrane and the cathode are clamped, and the proton exchange membrane is a gas-permeable proton exchange membrane.

2. The device for degrading the gaseous organic pollutant through electrochemical process according to claim 1, wherein:
an aperture of a pore in the gas-permeable proton exchange membrane ranges from 0.1 μm to 20,000 μm; and/or
a density of the pore in the gas-permeable proton exchange membrane ranges from 2 ppi to 10000 ppi.

3. The device for degrading the gaseous organic pollutant through electrochemical process according to claim 1, wherein the gas-permeable proton exchange membrane has a thickness of 5 μm to 3000 μm.

4. The device for degrading the gaseous organic pollutant through electrochemical process according to claim 1, wherein the anode is provided with a titanium suboxide material coating.

5. The device for degrading the gaseous organic pollutant through electrochemical process according to claim 4, wherein the titanium suboxide material coating has a thickness of 0.1 nm to 500 μm.

6. The device for degrading the gaseous organic pollutant through electrochemical process according to claim 4, wherein the anode is a gas-permeable metal electrode, and the gas-permeable metal electrode is selected from one of a foam titanium electrode, a foam titanium alloy electrode, a titanium mesh electrode, and a titanium alloy mesh electrode.

7. The device for degrading the gaseous organic pollutant through electrochemical process according to claim 1, wherein the cathode is a gas-permeable electrode loaded with an oxygen reduction catalyst, the oxygen reduction catalyst is made of at least one of platinum, rhodium, ruthenium, palladium, nickel, cobalt oxide, iron compounds, and molybdenum compounds;
the gas-permeable electrode is selected from one of a carbon paper electrode, a carbon fiber fabric electrode, a foam nickel electrode, a foam titanium electrode, a foam titanium alloy electrode, a titanium mesh foam electrode, and a titanium alloy mesh foam electrode;
and/or, a plurality of electrochemical reactors are provided in series.

8. A method for degrading a gaseous organic pollutant through electrochemical process, applied to the device for degrading the gaseous organic pollutant through electrochemical process according to claim 1, comprising:
applying a direct current voltage between the cathode and the anode; and
inputting a gas containing the gaseous organic pollutant from the anode;
wherein the gas containing the gaseous organic pollutant is degraded at the anode, and the degraded gas passes through the proton exchange membrane and the cathode in turn, and is discharged.

9. The method for degrading the gaseous organic pollutant through electrochemical process according to claim 8, wherein the gas containing the gaseous organic pollutant has a relative humidity of 2% to 100%.

10. The method for degrading the gaseous organic pollutant through electrochemical process according to claim 8, wherein:
the direct current voltage ranges from 0.3V to 36V; and/or
a temperature during a degradation of the gaseous organic pollutant is controlled within a range of −40° C. to 70° C.
